(19) United States
(12) Patent Application Publication
(10) Pub. No.: US 2005/0284381 A1
(43) Pub. Date: Dec. 29, 2005

(54) Livestock facility equipment network

(76) Inventors: Timothy L. Bell, St. Louis, MO (US); Roger D. Chamberlain, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/860,890

(22) Filed: Jun. 4, 2004

(51) Int. Cl. A01K 5/02

(52) U.S. Cl. 119/51.02

(57) ABSTRACT

An expandable livestock facility equipment network over which data is received from various automated pieces of equipment or monitors, and utilized by a control unit to provide an overall indication of the status of the livestock facility, including feed supply management, animal health conditions, and equipment operational conditions.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention is related to a livestock facility consumables tracking system, and in particular, to an expandable livestock facility equipment network adapted to track inventory and usage of feed supplies, the operational status of feeding equipment, and the health of livestock in an automated livestock facility using a network of interconnected sensors.

Modern farms often utilize automation in the monitoring and delivery of feed and water to livestock. Examples of farm and livestock automation include the use of water meters to document the delivery or consumption of water by a group of animals, automatic feeders that deliver controlled quantities of feed to feeding stations at predetermined times of day, regulating the feed available to the animals, and inventory measurement systems (e.g., grain bin weighing systems), that quantify the available inventory of feed.

A typical grain inventory measurement system, such as shown in U.S. Pat. No. 6,636,820 B2 to Livingston utilizes one or more load cells disposed in operative relationship to a single feed silo, such as under the support legs, which provides a load measurement to a display unit. The measurement shown on the display unit is representative of the weight of feed stored in the silo, and is calculated using one or more predetermined values, such as the unloaded weight of the silo itself. Hence, to determine an available inventory, a displayed measurement for each feed silo in a facility must be individually read.

Conventionally, a feed delivery system will include at least two feed silos, a feed delivery pathway, such as a tube, and an auger mechanism disposed within the feed delivery pathway to move the feed through the system to one or more animal feed stations. Due to the need to periodically empty and dry out each feed silo, feed is preferably drawn from one silo at a time, until one is emptied, at which point, the feed supply is switched to a second feed silo in the system while the empty silo is cleaned or dried. Subsequently, as the second silo nears an empty state, the first silo is refilled, and the feed supply returned thereto upon emptying of the second silo.

Animal feed consumption monitoring systems, such as shown in U.S. Pat. No. 5,559,716 to Gaalswyk, traditionally utilize a sensor configured to detect a flow of electrical current through the feed delivery system auger motor. The sensor signals are utilized to identify the length of time during which the auger motor is active, from which a determination of the amount of feed delivered can be calculated utilizing predetermined feed delivery rates. However, these systems suffer several drawbacks. For example, the actuation of the auger motor does not directly correspond with the actual delivery of feed to a feeding station. Feed may be unevenly distributed within the feed delivery system, blocked from movement, or completely absent. Furthermore, at different stages of animal growth, different feed mixtures are employed, each having different flow characteristics through the feed delivery system, which much be accounted for when calculating an amount delivered by the auger motor.

Traditionally, these automated pieces of equipment or monitors are operated in isolation and do not coordinate the acquired information available across multiple units, or between different types of equipment or monitors. Individual components or monitors may be provided with timer alarms set to indicate if the component has been in operation for an excessive period of time, and these systems can close an alarm relay to signal the alarm condition at that piece of equipment. However, currently available systems do not provide immediate notification of an alarm condition to an operator without initially awaiting for the predetermined excess period of time. Furthermore, currently available systems do not provide detailed diagnostic information regarding the specific nature or source of the alarm condition in animal feed systems. Hence, diagnosis of potentially serious problems in equipment operation and animal health may be missed or delayed. For example, it has been determined that for every six hours during which feed delivery to hogs is delayed, development to market weight is delayed by nearly three days. In a feed delivery system which utilizes only activation of a feed delivery auger motor, failure to dispense feed from a storage silo will not be detected, but auger motor activation will be, providing the false impression that a quantity of feed was delivered to a feeding station. For example, monitors on conventional systems are set to signal an alarm condition after at least four hours of auger motor operation. The four hour time limit is typically based upon the length of time taken to fill up an empty feed system. However, the conventional system can not provide an indication if the slide gate at the grain silo was open or closed, if there was no feed present in the grain silo, or if a feed bridge condition has occurred within the feed system, blocking feed from being delivered to the feed troughs.

Accordingly, it would be advantageous to provide an expandable livestock facility equipment network over which data could be received from various sensors associated with automated pieces of equipment and feed storage units, and utilized in combination to track trends and to provide an overall indication of the status of the livestock facility feed delivery systems, animal health conditions, and equipment operational conditions.

### BRIEF SUMMARY OF THE INVENTION

Briefly stated, a preferred embodiment of the present invention provides a livestock facility equipment network over which data is received from two or more automated pieces of equipment or equipment monitors, and utilized by a control unit to provide an overall indication of the status of the livestock facility, including feed supply management, animal health conditions, and equipment operational conditions.

In an alternate embodiment, a livestock feed delivery system including at least one livestock feed silo, a livestock feeding station, and an auger driven feed delivery pathway coupled between the feed silo and the feeding station is provided with a set of monitoring sensors. The monitoring sensors include at least one load sensor associated with the feed silo for obtaining measurements representative of an amount of feed stored therein, and at least one sensor associated with the auger driven feed delivery pathway capable of detecting activation of the auger mechanism. Each sensor is operatively coupled to a control unit, either directly or via a wireless communications network. The control system is configured with a microprocessor adapted to receive signals from each sensor, and having software configured to utilize the received signals to provide an overall indication of the status of the livestock facility, including feed management, animal health conditions, and equipment conditions.

In an alternate embodiment of the present invention, a livestock feed delivery system is provided with a set of monitoring sensors. The monitoring sensors include at least one load sensor associated with a feed silo for obtaining measurements representative of an amount of feed stored therein, and at least one sensor associated with an auger driven feed delivery pathway capable of detecting activation of the auger mechanism. Each sensor is operatively coupled to a control unit, either directly or via a wireless communications network. The control system is configured with a microprocessor adapted to receive signals from each sensor. The microprocessor is configured with a set of software instructions for processing the received signals and providing an output to an operator associated with the received signals.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a prior art grain silo incorporating load cell sensors into the supporting structure;

FIG. 2 is a prior art grain silo and auger driven feed delivery system incorporating an auger motor operational sensor; and

FIG. 3 is a diagrammatic representation of the components of one embodiment of the present invention;

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

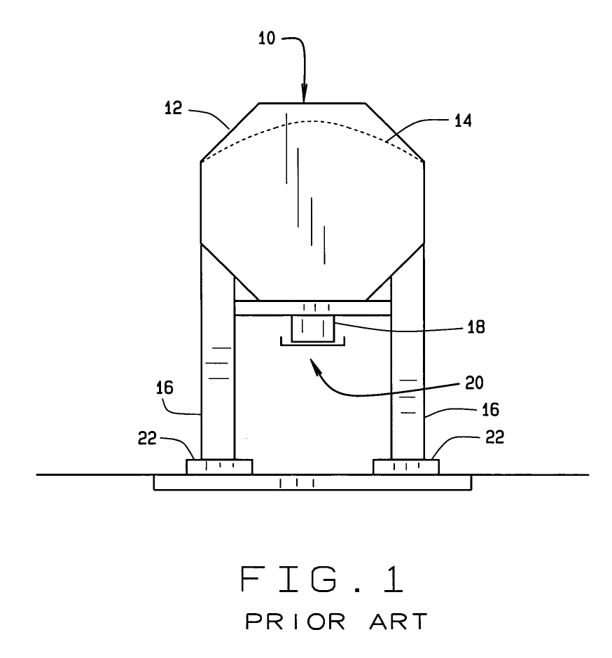

Turning to FIG. 1, a conventional grain silo is shown at 10, having a housing 12 within which is stored a quantity of grain or bulk feed 14. The housing 12 is typically supported by a set of legs 16, elevating the housing 12 above ground, such that bulk feed 14 may be gravity dispensed from a hopper 18 at the base of the housing 12, having a slide gate opening 20. A set of load sensors 22 are associated with the legs 16 of the grain silo 10, and provide signals indicative of the load carried by each leg 16.

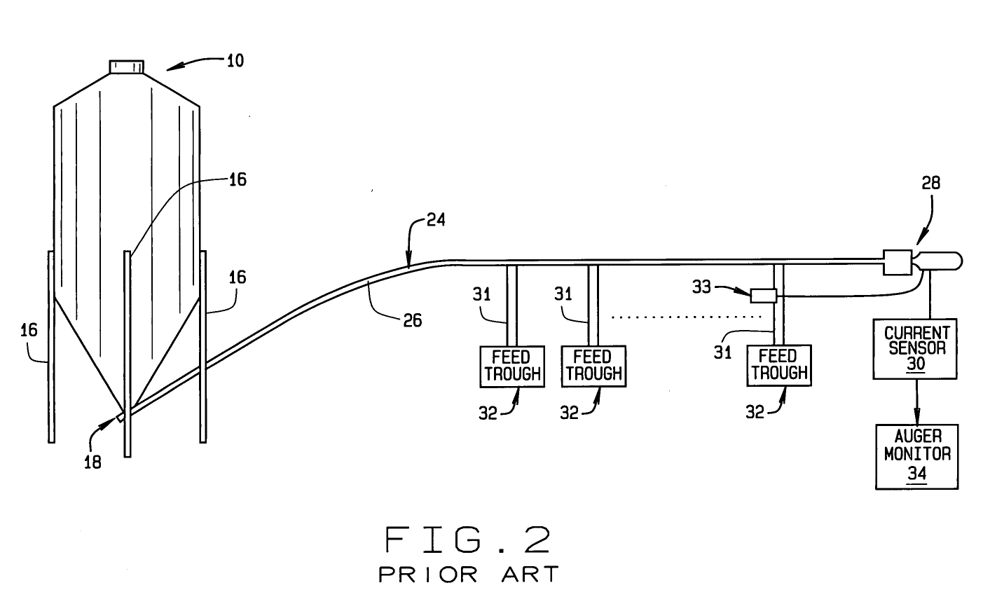

As shown in FIG. 2, the hopper 18 of the grain silo 10 is commonly coupled to a feed delivery mechanism 24 consisting of a feed line 26 driven by a motorized auger 28. To dispense feed, an operator will manually open the slide gate opening 20 at the base of the hopper 18, and feed is dispensed into the feed line 26. Activation of the motorized auger 28 moves the feed continuously through the feed line 26 to drop tubes 31 at one or more feed delivery stations or feed troughs 32. When a feed trough 32 is empty, the feed drops into the feed trough 32 from the feed line 26. When the feed trough 32 is full, the feed then fills the drop tube 31 and continues down the feed line 26 to the next feed trough 32. When the last feed trough 32 is filled, the feed in the last drop tube 31 builds up against a feed sensor 33, signaling that the entire “feed system” has been filled. The signal from the feed sensor 33 is typically utilized to shut down the motorized auger 28. An operational state sensor 30, typically a current flow sensor, monitors the motorized auger 28, and provides a signal representative of a flow of electrical current at the motorized auger 28 to another electronic device that monitors the auger motor to determine the amount of feed delivered by the motorized auger 28.

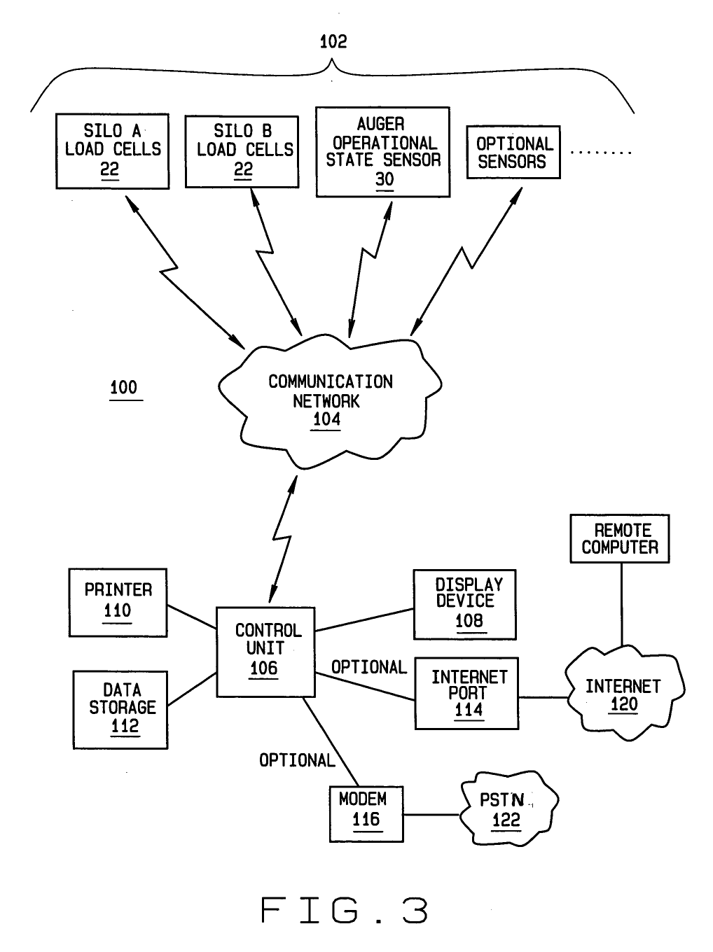

Turning to FIG. 3, the livestock facility equipment network of the present invention is shown generally at 100. The network includes a set of sensors 102 associated with individual components in a livestock facility. The sensors 102 preferably include sets of load sensors 22 associated with two or more grain silos 10 and at least one operational state sensors 30 associated with a motorized auger 28 in a feed delivery mechanism interconnected to the two or more grain silos 10. Optionally, additional sensors 102 such as temperature gauges, water flow sensors, and current flow sensors may be included within the network 100.

Each sensor 102 in the livestock facility equipment network 100 is linked to a communications network 104 for communication with a control unit 106 in a conventional manner. For example, each sensor 102 may be configured to communicate via a connecting communications cable such as an Ethernet connection, an RS-485 network, or through suitable transceivers establishing a wireless communications link such as a Bluetooth or Wi-Fi communications link. Communications may be continuous or periodic, as is well understood to those of ordinary skill in the art.

The control unit 106 is configured with a microprocessor and one or more software applications to receive signals from each sensor 102 in the livestock facility equipment network 100, and to process the received signals to provide an operator with information associated with one or more predetermined parameters of the livestock facility, including, but not limited to, the status of the livestock facility, feed supply status, animal health conditions, and equipment operational conditions. The control unit 106 provides for an interconnection of sensors 102 into an integrated system, fusing the data provided from each individual sensor into an integrated set of information, and drawing higher-level conclusions about the integrated whole than is possible using the disparate data individually. Preferably, the control unit 106 is operatively coupled to a display unit 108 for providing a visual display of information to an operator, to a printer 110 for providing a printout or written record of the received signals or facility status, and to a data storage device 112.

Those of ordinary skill in the art will recognize that the physical location of the control unit 106 is not restricted to placement within a livestock facility, but rather, may be located remote from the livestock facility within which the set of sensors 102 is disposed, allowing an operator to remotely monitor operations at the livestock facility. Alternatively, the control unit 106 may be configured to communication with one or more remote computer systems via an external communications network, such as the Internet 120, through an internet port 114, permitting an operator to check the status of the livestock facility from a remove location. Similarly, the control unit 106 may optionally include a modem 116, through which an operator can access and/or control the control unit 106 from a remote location via a telephone system 122.

The livestock facility equipment network 100 may be configured to utilize information from sets of sensors 102 for a variety of purposes including equipment operational status monitoring, feed inventory monitoring, and livestock health.

For example, grain silos 10 are typically utilized in pairs as part of a feed supply and delivery system. Opening and closing of the hoppers 18 to permit grain flow to the feed line 26 is a manual operation. The control unit 106 of the present invention may optionally be configured to monitor signals received from the associated load sensors 22 for each grain silo 10 at the same time signals from an operational state sensor 30 associated with a motorized auger 28 in a feed delivery mechanism indicated that the motorized auger 28 is activated to delivery feed to a feeding station. If the control unit 106 identified that the signals from the load sensors 22 are not indicating a change in stored feed quantities (or weights) with the associated grain silos 10, over the period of time during which the motorized auger 28 is activated, a warning indication is provided to an operator. Activation of the motorized auger 28 without an associated change in stored feed quantity in the interconnected gain silos 10 may indicate failure to open the hoppers 18, a feed jam or feed bridge formation within the feed delivery mechanism, or some other malfunction which would not be detectable by monitoring only the operational state of the motorized auger 28.

Correspondingly, a detection by the control unit 106 of a change in the stored feed quantity (or weight) in an associated grain silo 10 with the motorized auger 28 in an inactive stage may indicate an addition or removal of feed supplies 14 from the grain silo 10. The control unit 106 may be further configured to record the amount of change in the data storage 112, display the change on the display device 108, or provide printed record at the printer 110 for use in comparing with delivery invoices from a feed supplier. Monitoring the quantity (or weight) of feed 14 dispensed from a grain silo 10 during operation of a motorized auger 28 reduces the possibility of operator miscalculations in the amount of feed 14 delivered to a livestock feeding station arising from feed flow rate calculations which vary depending upon the type of feed 14 in the feed silo 10.

In an alternative embodiment, the control unit 106 may be configured to monitor the stored feed quantity (or weight) in the grain silos 10, and to provide an operator with a warning as the stored feed quantity (or weight) approaches an “empty” condition, thereby providing the operator with sufficient warning to timely arrange for delivery of additional feed supplies.

In an alternate embodiment, the control unit 106 of the present invention is configured with software instructions to utilize the received signals from the set of sensors 102 to provide a general indication of livestock health. At various stages of growth and development, the quantities of feed and water consumed by various types of livestock are well understood. The control unit 106 is configured to utilize feed supply inventory information obtained from load sensors 22 associated with grain silos 10, and optional water usage measurements obtained from a water meter, to identify usage and trends in the livestock consumption of feed and water that are outside given specified tolerances. Suitable indicators or warnings are provided to an operator. For example, the control unit 106 may be configured to use feed supply inventory information obtained from load sensors 22 associated with grain silos 10, and optional water usage measurements obtained from a water meter, to compare actual animal feed and water consumption with a predicted level of feed and/or water consumption based on the number of animals present in the livestock facility, and their ages. Alternatively, the control unit 106 may be configured to maintain a record of feed and/or water consumption for a select period of time, to establish an average consumption, and to notify an operator of a deviation in consumption from the establish average by a predetermined amount.

The present invention can be embodied in-part the form of computer-implemented processes and apparatuses for practicing those processes. The present invention can also be embodied in-part the form of computer program code containing instructions embodied in tangible media, such as floppy diskettes, CD-ROMs, hard drives, or an other computer readable storage medium, wherein, when the computer program code is loaded into, and executed by, an electronic device such as a computer, micro-processor or logic circuit, the device becomes an apparatus for practicing the invention.

The present invention can also be embodied in-part the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented in a general-purpose microprocessor, the computer program code segments configure the microprocessor to create specific logic circuits.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A livestock facility equipment network, comprising:
a data communications network;
a plurality of monitoring components, each associated with at least one monitored livestock facility device, operatively coupled to said data communications network, said monitoring components each configured to generate data associated with at least one of said monitored livestock facility devices for communication over said data communications network;
a control component operatively coupled to said data communications network, said control component configured to receive data associated with each of said monitored livestock facility devices over said data communications network, and to utilize said received data to generate at least one indication of a status of a livestock facility incorporating said plurality of monitored livestock facility devices.

2. The livestock facility equipment network of claim 1 wherein at least one of said plurality of monitoring components is a water flow meter.

3. The livestock facility equipment network of claim 2 wherein said associated monitored livestock facility device is a livestock drinking water dispenser.

4. The livestock facility equipment network of claim 1 wherein at least one of said plurality of monitoring components is an electrical current sensor.

5. The livestock facility equipment network of claim 4 wherein said associated monitored livestock facility device is an auger associated with a livestock feed delivery mechanism.

6. The livestock facility equipment network of claim 1 wherein at least one of said plurality of monitoring components is a load sensor.

7. The livestock facility equipment network of claim 6 wherein said associated monitored livestock facility device is a livestock feed storage silo.

8. The livestock facility equipment network of claim 1 where said data communications network is a wireless communications network.

9. The livestock facility equipment network of claim 1 wherein said control component is configured with a software application to utilize said received data to generate an indication of available feed supplies.

10. The livestock facility equipment network of claim 1 wherein said control component is configured with a software application to utilize said received data to generate an indication of livestock health conditions from feed consumption.

11. The livestock facility equipment network of claim 1 wherein said control component is configured with a software application to utilize said received data to generate an operational status indication of said associated monitored livestock facility device.

12. A method for monitoring animal health in a livestock facility having at least one feed delivery system including a plurality of monitoring devices, comprising:
acquiring feed delivery data from the plurality of monitoring devices associated with the at least one feed delivery system;
communicating said acquired feed delivery data to a control system;
comparing, at said control system, said acquired feed delivery data with one or more predetermined parameters associated with animal health; and
providing an animal health status associated with said comparison of acquired feed delivery data and said predetermined parameters.

13. The method of claim 12 for monitoring animal health in a livestock facility wherein said at least one feed delivery system includes a livestock drinking water delivery system; and
wherein said acquired feed delivery data includes a measure of drinking water usage.

14. The method of claim 12 for monitoring animal health in a livestock facility wherein the step of acquiring feed delivery data includes acquiring feed delivery data from at least one livestock drinking water delivery system and at least one livestock feed delivery system.

15. A livestock facility equipment monitoring system for monitoring equipment in a livestock facility including a plurality of feed storage silos interconnected with an auger driven feed delivery mechanism, comprising:
at least one load sensor associated with each feed storage silo, each of said at least one load sensors configured to provide a signal corresponding to an amount of feed stored within said associated feed storage silo;
at least one activation sensor associated with the auger driven feed delivery mechanism, said activation sensor configured to provide a signal corresponding to an operational state of the auger driven feed delivery system;
a control component operatively coupled to each of said load sensors and said at least one activation sensor to receive said feed storage signals and said feed delivery mechanism operational state signal; and
wherein said control component is configured to utilize said received signals to monitor at least one predetermined parameter associated with the livestock facility.

16. The livestock facility equipment network of claim 5 wherein said control component is configured to utilize said received data to monitor a dispensation of feed from at least one feed storage silo through said feed delivery mechanism.

17. The livestock facility equipment network of claim 7 wherein said control component is configured to utilize said received data to monitor an addition of feed to at least one of said feed storage silo.

18. The livestock facility equipment monitoring system of claim 15 further including:
at least one flow sensor operatively coupled to a livestock water delivery system, said at least one flow sensor configured to provide a signal corresponding to a quantity of water dispensed through said livestock water delivery system; and
wherein said control component is operatively coupled to said at least one flow sensor to receive said water dispensation signal.

19. The livestock facility equipment network of claim 1 wherein said control component is configured to utilize said received data to calculate at least one feed consumption trend.

20. The livestock facility equipment network of claim 19 wherein said control component is configured to compare said calculated at least one feed consumption trend with at least one predetermined feed consumption curve to identify a deviation exceeding a predetermined threshold.

21. The livestock facility equipment monitoring system of claim 15 wherein said control component is configured to generate an operator warning responsive to a feed delivery mechanism operational state signal indicating activation and each of said feed storage signals remaining unchanged.

22. The livestock facility equipment network of claim 1 wherein said control component is configured to communicate with at least one external computer system via said data communications network.

23. The livestock facility equipment network of claim 22 wherein said data communications network Is the Internet.

24. The livestock facility equipment network of claim 1 wherein said generated indication identifies an operational status of the livestock facility.

25. The livestock facility equipment network of claim 1 wherein said generated indication identifies a level of feed supplies within the livestock facility.

26. The livestock facility equipment network of claim 1 wherein said generated indication identifies the overall health of livestock within the livestock facility.

27. The livestock facility equipment monitoring system network of claim 1 wherein said generated indication identifies an average amount of feed consumed over a predetermined period of time.

28. The livestock facility equipment network of claim 27 wherein control component is further configured to compare a current feed consumption measurement with said average feed consumption to identify a deviation.
